(19) United States
(12) Patent Application Publication
(10) Pub. No.: US 2025/0059355 A1
(43) Pub. Date: Feb. 20, 2025

(54) SILICA PARTICLE DISPERSION LIQUID

(71) Applicants: AGC INC., Tokyo (JP); AGC SI-TECH CO., LTD., Kitakyushu-shi (JP)

(72) Inventor: Hiromichi KAMO, Tokyo (JP)

(73) Assignees: AGC INC., Tokyo (JP); AGC SI-TECH CO., LTD., Kitakyushu-shi (JP)

(21) Appl. No.: 18/938,403

(22) Filed: Nov. 6, 2024

Related U.S. Application Data
(63) Continuation of application No. PCT/JP2023/016364, filed on Apr. 25, 2023.

(30) Foreign Application Priority Data
May 9, 2022 (JP) 2022-077093

(51) Int. Cl. C08K 9/06; C08K 7/18; C09C 1/30

(52) U.S. Cl. CPC C08K 9/06; C08K 7/18; C09C 1/3009; C09C 1/3072; C09C 1/3081; C01P 2004/32; C01P 2004/61; C01P 2004/62; C01P 2006/12; C01P 2006/22

(57) ABSTRACT

The present invention relates to a silica particle dispersion including spherical silica particles and a solvent, in which the spherical silica particles have a median diameter d50 of 0.5 μm to 20 μm, and a product A×d50 of 2.7 μm·m²/g to 5.0 μm·m²/g, the product A×d50 being a product of a specific surface area A (m²/g) of the spherical silica particles and the median diameter d50 (μm).

### CROSS-REFERENCE TO RELATED APPLICATIONS

This is a continuation of International Application No. PCT/JP2023/016364 filed on Apr. 25, 2023, and claims priority from Japanese Patent Application No. 2022-077093 filed on May 9, 2022, the entire content of which is incorporated herein by reference.

### TECHNICAL FIELD

The present invention relates to a silica particle dispersion in which silica particles are dispersed in a solvent.

### BACKGROUND ART

In related art, silica particles have been used for various applications, such as electronic materials for printed wiring boards or package wiring boards, optical materials for lenses or optical films, functional materials for catalysts or catalyst carriers, and pigments for paints or cosmetics. For example, the silica particles are used in an electronic substrate, taking advantage of low dielectric properties thereof.

Since the silica particles are likely to aggregate when used in a dry powder state, the silica particles are used in the form of a dispersion in which the silica particles are dispersed in a solvent such as water or a resin according to intended use, and various silica particle dispersions and slurries containing the silica particle dispersions have been proposed.

For example, Patent Literature 1 has proposed an electronic material slurry including an electronic material filler that is a silica particle material and a liquid dispersion medium that does not substantially contain water, the silica particle material having a particle diameter of 100 nm to 2,000 nm or a specific surface area of 2 m²/g to 35 m²/g, and an amount of water generated when heated at 200° C. of 40 ppm or less per 1 m² of surface area, and being subjected to surface treatment with a silane compound having a vinyl group, a phenyl group, a phenylamino group, an alkyl group having 4 or more carbon atoms, a methacrylic group, or an epoxy group.

Patent Literature 2 has proposed an anti-reflection film-forming coating liquid including silica-based hollow fine particles (A) having an average particle diameter (Dpa) in a range of 30 nm to 200 nm, silica solid fine particles (B) having an average particle diameter (Dpb) in a range of 5 nm to 80 nm, and a solvent, in which a concentration (CA) of the silica-based hollow fine particles (A) is in a range of 0.2 wt % to 8 wt % in terms of solid content, a concentration (CB) of the silica solid fine particles (B) is in a range of 0.2 wt % to 8 wt % in terms of solid content, and a weight ratio (B/A) of the silica solid fine particles (B) to the silica-based hollow fine particles (A) is 0.25 to 4.

Patent Literature 3 has proposed a silica-based particle dispersion containing silica-based particles having an average particle diameter of 5 to 40 nm and having a proportion (hollow ratio) of the number of hollow particles to the total number of hollow particles and solid particles of 70% or more.

### CITATION LIST

### Patent Literature

Patent Literature 1: JP2020-097498A
Patent Literature 2: JP2015-102666A
Patent Literature 3: JP2018-123043A

### SUMMARY OF INVENTION

### Technical Problem

However, when the silica particle dispersion in the related art is contained in a resin composition to form a film, the silica particles tend to become grainy, peel strength is low, and it is difficult to obtain an effect expected from the silica particles. In particular, when the silica particle dispersion is used for the purpose of reducing dielectric constant, the reduction in dielectric constant can be achieved by reducing a surface area or increasing a particle diameter of the silica particles. However, since a contact area between particles becomes large, the peel strength tends to decrease.

The present invention has been made in view of the above problems, and an object thereof is to provide a silica particle dispersion that can reduce graininess during film formation and increase peel strength.

### Solution to Problem

The present invention relates to the following (1) to (9).

(1) A silica particle dispersion including spherical silica particles and a solvent, in which the spherical silica particles have a median diameter d50 of 0.5 μm to 20 μm, and a product A×d50 of 2.7 μm·m²/g to 5.0 μm·m²/g, the product A×d50 being a product of a specific surface area A (m²/g) of the spherical silica particles and the median diameter d50 (μm).

(2) The silica particle dispersion according to (1), in which the spherical silica particles have a specific surface area of 0.1 m²/g to 10 m²/g.

(3) The silica particle dispersion according to (1) or (2), in which the spherical silica particles have a viscosity measured by the following measurement method of 5,000 mPa·s or less,

### (Measurement Method)

the silica particle dispersion is dried to obtain powdery spherical silica particles, 8 parts by mass of the powdery spherical silica particles obtained and 6 parts by mass of boiled linseed oil are mixed and kneaded at 2000 rpm for 3 minutes to obtain a kneaded product, and the kneaded product is measured for 30 seconds at a shear rate of 1 s⁻¹ using a rotary rheometer to determine the viscosity at 30 seconds.

(4) The silica particle dispersion according to any one of (1) to (3), further including a silane compound having at least one group selected from the group consisting of a vinyl group, a phenyl group, a phenylamino group, an alkyl group having 4 or more carbon atoms, a methacrylic group, and an epoxy group.

(5) The silica particle dispersion according to any one of (1) to (4), further including an organic thixotropic agent.

(6) The silica particle dispersion according to any one of (1) to (5), in which the solvent includes at least one selected from the group consisting of water, hydrocarbons, alcohols, acetate esters, ketones, cellosolves, glycol ethers, chlorohydrocarbons, and polar solvents.

(7) The silica particle dispersion according to any one of (1) to (6), having a viscosity of 20 mPa·s to 20,000 mPa·s at 25° C. when a solid content concentration of the spherical silica particles is 70 mass %.

(8) A resin composition including the silica particle dispersion according to any one of (1) to (7).

(9) A method for producing a silica particle dispersion, the method including: mixing a solvent with powder of spherical silica particles, the spherical silica particles having a median diameter d50 of 0.5 μm to 20 μm and a product A×d50, which is a product of a specific surface area A (m²/g) and the median diameter d50 (μm), of 2.7 μm·m²/g to 5.0 μm·m²/g; and
subjecting the mixed liquid to dispersion treatment, followed by classifying to remove aggregates of the spherical silica particles.

### Advantageous Effects of Invention

In the silica particle dispersion of the present invention, since the spherical silica particles are uniformly dispersed in the liquid without being aggregated, it is possible to reduce graininess when the resin composition including the silica particle dispersion of the present invention is formed into a film, and to increase peel strength.

### DESCRIPTION OF EMBODIMENTS

The present invention will be described below, but the present invention is not limited to examples described below. In addition, in the present specification, an expression “to” used to express a numerical range includes numerical values before and after it as a lower limit value and an upper limit value of the range, respectively.

Moreover, in the present specification, “mass” is synonymous with “weight”.

### <Silica Particle Dispersion>

A silica particle dispersion of the present invention includes spherical silica particles and a solvent, in which the spherical silica particles have a median diameter d50 of 0.5 μm to 20 μm, and a product A×d50, which is a product of a specific surface area A (m²/g) and the median diameter d50 (μm), of 2.7 μm·m²/g to 5.0 μm·m²/g. In the silica particle dispersion of the present invention, the spherical silica particles are uniformly dispersed without being aggregated, dispersion stability of the spherical silica particles in the dispersion is improved, it is possible to reduce graininess when the silica particle dispersion is included in a resin composition to form a film, and peel strength can be increased.

### (Solvent)

A solvent serving as a dispersion medium of the silica particle dispersion may be freely selected according to intended use, and examples thereof include water, hydrocarbons, alcohols, acetate esters, ketones, cellosolves, glycol ethers, chlorohydrocarbons, and polar solvents. The solvent preferably includes at least one selected from the group consisting of these solvents.

Examples of the hydrocarbons include toluene, methylcyclohexane, normal heptane, and m-xylene. Examples of the alcohols include ethanol, isopropyl alcohol, 1-propyl alcohol, isobutyl alcohol, 1-butanol, and 2-butanol. Examples of the acetate esters include propyl acetate, isobutyl acetate, and butyl acetate. Examples of the ketones include methyl ethyl ketone, methyl isobutyl ketone, and cyclohexanone. Examples of the cellosolves include ethylene glycol monomethyl ether and ethylene glycol monoethyl ether. Examples of the glycol ethers include 1-methoxy-2-propanol, 1-methoxypropyl-2-acetate, 1-ethoxy-2-propanol, and ethyl 3-ethoxypropionate. Examples of the chlorohydrocarbons include trichloroethylene and tetrachloroethylene. Examples of the polar solvents include N-methyl-2-pyrrolidone.

The solvent may be appropriately selected according to the field of intended use. For example, when the solvent is used for an insulating layer of a wiring board of an electronic device, ketones and hydrocarbons are preferably used, and specifically, methyl ethyl ketone (MEK), toluene, and the like are preferably used.

When the silica particle dispersion of the present invention is used in a curable composition, a liquid main agent or a curing agent itself may be used as a solvent. Examples of the main agent include epoxy resins, polyphenylene ether resins, polyester resins, polyimide resins, phenol resins, ortho-divinylbenzene resins, and the like. Examples of the curing agent include polyamine curing agents, acid anhydride curing agents, phenol curing agents, active ester curing agents, and peroxides.

The solvent is preferably included in a range of 15 mass % to 90 mass % in the silica particle dispersion. When a content of the solvent is 15 mass % or more, the spherical silica particles can be uniformly dispersed, and the viscosity of the dispersion is not too high, making it easy to handle. In addition, when the content of the solvent is 90 mass % or less, the silica particle dispersion is in a liquid state and thus can be used as it is in a dispersed state. The content of the solvent in the silica particle dispersion is more preferably 20 mass % or more, still more preferably 25 mass % or more, particularly preferably 30 mass % or more, and most preferably 40 mass % or more, and is more preferably 85 mass % or less, still more preferably 80 mass % or less, and particularly preferably 75 mass % or less.

### (Spherical Silica Particles)

The spherical silica particles are solid silica, and have a median diameter d50 of 0.5 μm to 20 μm and a product A×d50, which is a product of a specific surface area A (m²/g) and the median diameter d50 (μm), of 2.7 μm·m²/g to 5.0 μm·m²/g (2.7<A×d50 (μm·m²/g)≤5.0).

The following physical properties of the spherical silica particles can be confirmed by drying the silica particle dispersion to obtain powdered silica particles.

When the median diameter d50 of the spherical silica particles is within the above range, the silica particle dispersion has a viscosity that is easy to handle and is less likely to become grainy during coating, so that the peel strength of the resin composition is appropriately maintained when the silica particle dispersion is used as the resin composition. In addition, in the case where the median diameter becomes too large, a value of a particle gauge becomes large, and thus, when a resin composition including the spherical silica particles is formed into, for example, a sheet, a minimum thickness of the sheet becomes thick. Accordingly, in the present invention, the median diameter d50 of the spherical silica particles is in the range of 0.5 μm to 20 m. The median diameter d50 is preferably 1 μm or more, and an upper limit thereof is preferably 10 m or less, and more preferably 5 m or less.

The median diameter d50 is obtained by a laser diffraction particle size distribution analyzer (for example, “MT3300EXII” manufactured by MicrotracBEL Corp.).

The specific surface area A of the spherical silica particles is preferably in the range of 0.1 m²/g to 10 m²/g. In the case where the specific surface area is 0.1 m²/g or more, a contact point with the resin is sufficient when the spherical silica particles are included in the resin composition, and thus, the spherical silica particles become more compatible with the resin, and in the case where the specific surface area is 10 m²/g or less, the dielectric loss tangent can be reduced, and dispersibility in the resin composition can be improved. The specific surface area A is more preferably 8 m²/g or less, still more preferably 7 m²/g or less, and particularly preferably 5 m²/g or less. It is substantially difficult to obtain particles with the specific surface area A of less than 0.1 m²/g.

The specific surface area is obtained by a BET method based on a nitrogen adsorption method using the specific surface area and pore distribution measuring device (for example, “BELSORP-miniII” manufactured by MicrotracBEL Corp., “TriStar II” manufactured by Micromeritics Instrument Corporation).

The product A×d50 of the specific surface area A (m²/g) and the median diameter d50 (μm) of the spherical silica particles is 2.7 μm·m²/g to 5.0 μm·m²/g, preferably 2.7 μm·m²/g to 4.5 μm·m²/g, and more preferably 2.7 μm·m²/g to 4.0 μm·m²/g. A theoretical value of A×d50 is 2.7 [derived from specific surface area=6/(true density of silica of 2.2 (g/cm³)×median diameter d50 (μm))], and values below this theoretical value are practically unachievable. When the value of A×d50 is 5.0 μm·m²/g or less, the specific surface area per particle diameter decreases, and the dielectric loss tangent can be reduced.

The spherical silica particles preferably have a sphericity of 0.75 to 1.0. When the sphericity is too low, a contact area with a member in contact with silica particles in a resin layer in the resin composition including the silica particle dispersion decreases, resulting in a decrease in peel strength, and thus the sphericity is preferably 0.75 or more.

The sphericity can be represented by an average value obtained by measuring a longest diameter (DL) and a shortest diameter (DS) orthogonal to the longest diameter (DL) of arbitrary 100 particles in a photograph projection view that is obtained by capturing with a scanning electron microscope (SEM), and calculating a ratio (DS/DL) of the shortest diameter (DS) to the longest diameter (DL).

From the viewpoint of dispersibility and the like, the sphericity is more preferably 0.90 or more, still more preferably 0.93 or more, and is preferably closer to 1.0.

The spherical silica particles preferably have a viscosity of 5000 mPa·s or less measured by the following measurement method.

### (Measurement Method)

The silica particle dispersion is dried to obtain powdery spherical silica particles, 8 parts by mass of the powdery spherical silica particles obtained and 6 parts by mass of boiled linseed oil are mixed and kneaded at 2000 rpm for 3 minutes to obtain a kneaded product, and the kneaded product is measured for 30 seconds at a shear rate of 1 s⁻¹ using a rotary rheometer to determine the viscosity at 30 seconds.

When the viscosity of the kneaded product at the shear rate of 1 s⁻¹ determined by the measurement method is 5000 mPa·s or less, it can be said that the silica particles are dense, and the peel strength of the resin composition can be improved. In addition, an amount of a solvent added at the time of forming a film of and molding the resin composition including the spherical silica particles can be reduced, a drying rate can be increased, and productivity can be improved. In addition, in the case where the specific surface area of the silica particles according to the particle diameter increases, the viscosity tends to increase when the silica particles are added to the resin composition, but the spherical silica particles can prevent an increase in the viscosity of the resin composition since the specific surface area thereof is small. The viscosity of the kneaded product is more preferably 4000 mPa·s or less, and still more preferably 3500 mPa·s or less.

A lower limit value of the viscosity of the kneaded product at the shear rate of 1 s⁻¹ is not particularly limited because the lower the viscosity, the better coatability of the resin composition and the higher the productivity.

The spherical silica particles preferably have a dielectric loss tangent in powder form at a frequency of 1 GHz of 0.0020 or less, more preferably 0.0010 or less, and still more preferably 0.0008 or less. In particular, in the measurement of the dielectric loss tangent and the permittivity of the powder, if the frequency is 10 GHz or more, a sample space becomes small and a measurement accuracy deteriorates, and thus, values measured at the frequency of 1 GHz are used in the present invention. In the case where the dielectric loss tangent at the frequency of 1 GHz of the spherical silica particles is 0.0020 or less, an excellent reduction effect of dielectric loss can be obtained, and thus, a substrate or sheet having improved high-frequency characteristics can be obtained. As the dielectric loss tangent is smaller, a transmission loss of a circuit is reduced, and thus, a lower limit value thereof is not particularly limited.

The dielectric loss tangent can be measured by a perturbation resonator method using a dedicated device (for example, “vector network analyzer E5063A” manufactured by KEYCOM Corp.).

An IR peak intensity in the vicinity of 3746 cm⁻¹, which is derived from an isolated silanol group on the surface of the spherical silica particles, is preferably 0.1 or less, more preferably 0.08 or less, and still more preferably 0.06 or less. The isolated silanol group is a silanol (Si—OH) group that is not bonded to water or the like adsorbed to the silica particles. An amount of the isolated silanol (Si—OH) group on the surface of the silica particles is obtained by IR measurement. Specifically, an IR spectrum is normalized at 800 cm⁻¹, a base line is aligned at 3800 cm⁻¹, and then a relative value of the Si—OH peak intensity in the vicinity of 3746 cm⁻¹ is obtained. In the case where the number of isolated silanol groups on the particle surface is large, the dielectric loss tends to increase when the member mixed with the resin is used for electronic applications, and in the case where the IR peak intensity in the vicinity of 3746 cm⁻¹, which is derived from the isolated silanol group on the particle surface, is 0.1 or less, the dielectric loss can be reduced.

A maximum IR peak intensity at 3300 cm⁻¹ to 3700 cm⁻¹, which is derived from a bonded silanol group on the surface of the spherical silica particles, is preferably 0.2 or less, more preferably 0.17 or less, and still more preferably 0.15 or less. The bonded silanol group is a silanol (Si—OH) group bonded to water adsorbed to the silica particles, or bonded to silanol on the silica surface. An amount of the bonded silanol (Si—OH) group on the surface of the silica particles is obtained by IR measurement. Specifically, the IR spectrum is normalized at 800 cm⁻¹, the base line is aligned at 3800 cm⁻¹, and then the relative value of the bonded Si—OH peak intensity is obtained from the maximum peak at 3300 cm⁻¹ to 3700 cm⁻¹. In the case where the number of bonded silanol groups on the particle surface is large, the dielectric loss tends to increase when the member mixed with the resin is used for electronic applications, and in the case where a maximum IR peak intensity at 3300 cm⁻¹ to 3700 cm⁻¹, which is derived from the bonded silanol group on the particle surface, is 0.2 or less, the dielectric loss can be reduced.

The spherical silica particles are preferably non-porous particles. In the case where the spherical silica particles are porous particles, an oil absorption value increases, the viscosity in the resin increases, the surface area increases, the amount of silanol (Si—OH) groups on the surface of the silica particles increases, and the dielectric loss tangent tends to deteriorate. Specifically, the oil absorption value is preferably 100 ml/100 g or less, more preferably 70 ml/100 g or less, and most preferably 50 ml/100 g or less. A lower limit value thereof is not particularly limited, but it is substantially difficult to set the oil absorption value to 20 ml/100 g or less.

The spherical silica particles preferably include titanium (Ti) in a range of 30 ppm to 1500 ppm, more preferably 100 ppm to 1000 ppm, and still more preferably 100 ppm to 500 ppm.

Ti is a component that is optionally included in the production of the spherical silica particles. In the production of the spherical silica particles, if fine powder is generated due to cracking of the silica particles, the fine powder adheres to a surface of a base particle, and the specific surface area of the particle is increased. By including Ti at the time of producing the spherical silica particles, it is easy to thermally compact during baking. Accordingly, it is difficult to crack during post-processing after baking, and thus, generation of the fine powder can be prevented, and the number of adhesive particles adhering to the surface of the silica base particles can be reduced, thereby preventing an increase in the specific surface area. By including 30 ppm or more of Ti, it is easy to thermally compact during baking, and thus, the generation of the fine powder due to cracking can be reduced, and in the case where a content of Ti is less than or equal to 1500 ppm, the above-described effect can be obtained, an increase in the amount of the silanol group can be prevented and deterioration of the dielectric loss tangent can be prevented.

The spherical silica particles may include an impurity element other than titanium (Ti) as long as the effect of the present invention is not impaired. Examples of the impurity element include Na, K, Mg, Ca, Al, and Fe in addition to Ti.

A content of an alkali metal and an alkaline earth metal in the impurity element is preferably 2000 ppm or less, more preferably 1000 ppm or less, and still more preferably 200 ppm or less in total.

The spherical silica particles may be treated with a silane coupling agent.

When the surface of the spherical silica particles is treated with the silane coupling agent, an amount of silanol groups remaining on the surface is reduced, the surface is hydrophobized, and the dielectric loss can be improved by preventing water adsorption. Further, when the resin composition is prepared, affinity with the resin is improved, and dispersibility and strength after resin film formation are improved.

The conditions for the surface treatment are not particularly limited, and general surface treatment conditions may be used, and a wet treatment method or a dry treatment method may be used. From the viewpoint of performing a uniform treatment, a wet treatment method is preferable.

Examples of the silane coupling agent include aminosilane coupling agents, epoxysilane coupling agents, mercaptosilane coupling agents, silane-based coupling agents, and organosilazane compounds. The silane coupling agent may be used alone or in combination of two or more kinds thereof.

Specifically, examples of the silane coupling agent include an aminosilane coupling agent such as aminopropylmethoxysilane, aminopropyltriethoxysilane, ureidopropyltriethoxysilane, N-phenylaminopropyltrimethoxysilane, and N-2(aminoethyl)aminopropyltrimethoxysilane, an epoxysilane coupling agent such as glycidoxypropyltrimethoxysilane, glycidoxypropyltriethoxysilane, glycidoxypropylmethyldiethoxysilane, glycidylbutyltrimethoxysilane, and (3,4-epoxycyclohexyl)ethyltrimethoxysilane, a mercaptosilane coupling agent such as mercaptopropyltrimethoxysilane and mercaptopropyltriethoxysilane, a silane coupling agent such as methyltrimethoxysilane, vinyltrimethoxysilane, octadecyltrimethoxysilane, phenyltrimethoxysilane, methacroxypropyltrimethoxysilane, imidazolesilane, and triazinesilane, a fluorine-containing silane coupling agent such as CF₃(CF₂)₇CH₂CH₂Si(OCH₃)₃, CF₃(CF₂)₇CH₂CH₂SiCl₃, CF₃(CF₂)₇CH₂CH₂Si(CH₃)(OCH₃)₂, CF₃(CF₂)₇CH₂CH₂Si(CH₃)Cl₂, CF₃(CF₂)₅CH₂CH₂SiCl₃, CF₃(CF₂)₅CH₂CH₂Si(OCH₃)₃, CF₃CH₂CH₂SiCl₃, CF₃CH₂CH₂Si(OCH₃)₃, C₈F₁₇SO₂N(C₃H₇)CH₂CH₂CH₂Si(OCH₃)₃, C₇F₁₅CONHCH₂CH₂CH₂Si(OCH₃)₃, C₈F₁₇CO₂CH₂CH₂CH₂Si(OCH₃)₃, C₈F₁₇—O—CF(CF₃)CF₂—O—C₃H₆SiCl₃, and C₃F₇—O—(CF(CF₃)CF₂—O)₂—CF(CF₃)CONH—(CH₂)₃Si(OCH₃)₃, and an organosilazane compounds such as hexamethyldisilazane, hexaphenyldisilazane, trisilazane, cyclotrisilazane, and 1, 1,3,3,5,5-hexamethylcyclotrisilazane.

An adhesion amount of the silane coupling agent is preferably 0.01 parts by mass or more, more preferably 0.02 parts by mass or more, and still more preferably 0.10 parts by mass or more, and is preferably 5 parts by mass or less, and more preferably 2 parts by mass or less with respect to 100 parts by mass of the spherical silica particles.

The fact that the surface of the spherical silica particles is treated with the silane coupling agent can be confirmed by detecting a peak due to a substituent group of the silane coupling agent using IR. The adhesion amount of the silane coupling agent can be measured by an amount of carbon.

The spherical silica particles are preferably included in a range of 10 mass % to 85 mass % in the silica particle dispersion. When a content of the spherical silica particles is 10 mass % or more, desired peel strength can be imparted with a small amount of the silica particle dispersion added to the resin composition. When the content is 85 mass % or less, the viscosity of the dispersion is not excessively increased, making it easy to handle. The content of the spherical silica particles in the silica particle dispersion is more preferably 15 mass % or more, still more preferably 20 mass % or more, and particularly preferably 25 mass % or more, and is more preferably 80 mass % or less, still more preferably 75 mass % or less, particularly preferably 70 mass % or less, and most particularly preferably 60 mass % or less.

### (Silane Compound)

The silica particle dispersion of the present invention preferably includes a silane compound having at least one group selected from the group consisting of a vinyl group, a phenyl group, a phenylamino group, an alkyl group having 4 or more carbon atoms, a methacrylic group, and an epoxy group. By including the silane compound, when the silica particle dispersion is included in the resin composition, the surfaces of the spherical silica particles blend well with the resin, and thus the peel strength of the resin composition can be further increased. When the spherical silica particles are treated with the silane coupling agent, the silane compound is not necessarily added.

Examples of the silane compound include vinyl silane, phenyl silane, phenyl amino silane, hexyl silane, decyl silane, 3-methacryloxypropyltrimethoxysilane, and amino propyl silane. These may be used alone or in combination of two or more kinds thereof. Among them, from the viewpoint of interaction with the resin, a silane compound including a vinyl group, a phenyl group, a methacrylic group, an epoxy group, or a phenylamino group is preferable, a silane compound including a vinyl group, a phenyl group, a methacrylic group, or a phenylamino group is more preferable, and a silane compound including a phenyl group or a methacrylic group is still more preferable. In this case, the silica particles in the kneaded product described later and the silica particle dispersion of the present invention have the improved dispersibility, and it is particularly easy to maintain a balance between the viscosity thereof and the peel strength of a molded product formed therefrom.

The silane compound is preferably included in a range of 0.01 mass % to 5 mass % in the silica particle dispersion. In a case where the content of the silane compound is 0.01 mass % or more, when the silica particle dispersion is included in the resin composition, the compatibility between the spherical silica particles and the resin can be improved, and the peel strength of the resin composition can be increased. When the content is 5 mass % or less, the silane compound is prevented from remaining in the composition, and the influence on the physical properties of the resin composition can be reduced. The content of the silane compound in the silica particle dispersion is more preferably 0.02 mass % or more, still more preferably 0.04 mass % or more, and particularly preferably 0.05 mass % or more, and is more preferably 4 mass % or less, and particularly preferably 3 mass % or less.

### (Organic Thixotropic Agent)

The silica particle dispersion of the present invention preferably further includes an organic thixotropic agent.

The organic thixotropic agent is added for preventing aggregation and precipitation of the spherical silica particles in the silica particle dispersion and the resin composition or slurry including the silica particle dispersion, and for improving wettability of the flux to a cured product of the resin composition or slurry.

Examples of the organic thixotropic agent include fatty acid amides (amide wax) synthesized from vegetable oil fatty acid and amine; surfactants such as fatty acid esters, polyethers, sulfated oil, and higher alcohol sulfate; polycarboxylic acid esters; polycarboxylic acid amides; and urea modified compounds, but do not include hydrogenated castor oil-based agents called castor oil wax, and oxidized polyethylene-based agents which are waxes obtained by oxidizing polyethylene and introducing polar groups. The organic thixotropic agent may be used alone or in combination of two or more types thereof

The organic thixotropic agent is commercially available, and examples thereof include BYK (registered trademark)-R606, BYK (registered trademark)-405, BYK (registered trademark)-R605, BYK (registered trademark)-R607, BYK (registered trademark)-410, BYK (registered trademark)-411, BYK (registered trademark)-415, BYK (registered trademark)-430, BYK (registered trademark)-431, BYK (registered trademark)-7410ET, BYK (registered trademark)-7411ES (all manufactured by BYK Japan KK), Talen 1450, Talen 2000, Talen 2200A, Talen 7200-20, Talen 8200-20, Talen 8300-20, Talen 8700-20, Talen BA-600, Flownon SH-290, Flownon SH-295S, Flownon SH-350, and Flownon HR-2, Flownon HR-4AF (all manufactured by Kyoeisha Chemical Co., Ltd.).

The organic thixotropic agent is preferably included in a range of 0.01 mass % to 5 mass % in the silica particle dispersion. When the content of the organic thixotropic agent is 0.01 mass % or more, aggregation of the spherical silica particles in the dispersion is prevented. When the silica particle dispersion is included in the resin composition, accumulation of the resin between the spherical silica particles can be prevented. Accordingly, the peel strength of the resin composition can be increased. When the content of the organic thixotropic agent is 5 mass % or less, the organic thixotropic agent is prevented from remaining in the composition, and the influence on the physical properties of the resin composition can be reduced. The content of the organic thixotropic agent in the silica particle dispersion is more preferably 0.02 mass % or more, still more preferably 0.04 mass % or more, and particularly preferably 0.05 mass % or more, and is more preferably 4 mass % or less, still more preferably 3 mass % or less, and particularly preferably 2.5 mass % or less.

The silica particle dispersion of the present invention may include other optional components as long as the effects of the present invention are not impaired. Examples of the optional components include other inorganic fillers such as alumina, and cured compositions.

### (Physical Properties of Silica Particle Dispersion)

The silica particle dispersion of the present invention preferably has a viscosity of 20 mPa·s to 20,000 mPa·s at 25° C. when a solid content concentration of the spherical silica particles is 70 mass %.

When the silica particle dispersion has a viscosity of 20 mPa·s or more at 25° C. when a solid content concentration of the spherical silica particles is 50 mass %, settling (floating) separation of the silica can be prevented. When the viscosity is 20,000 mPa·s or less, the silica can be used while maintaining a dispersed state. The viscosity is more preferably 50 mPa·s or more, still more preferably 75 mPa·s or more, particularly preferably 100 mPa·s or more, and most preferably 500 mPa·s or more. Further, the viscosity is more preferably 15,000 mPa·s or less, still more preferably 12,000 mPa·s or less, and particularly preferably 10,000 mPa·s or less.

### <Method for Producing Silica Particle Dispersion>

The silica particle dispersion of the present invention is obtained by dispersing powder of spherical silica particles in a solvent. The spherical silica particles may be obtained by production or commercially available spherical silica particles may be used.

Hereinafter, a method for producing spherical silica particles and a method for producing a silica particle dispersion using the same will be described.

### (Method for Producing Spherical Silica Particles)

Examples of the method for producing spherical silica particles include a method of forming a spherical silica precursor by a wet method and obtaining spherical silica particles from the precursor. The wet method refers to a method including a step of obtaining a raw material of the spherical silica particles by using a liquid as a silica source and gelling the liquid. By using the wet method, spherical silica particles can be formed, and thus, there is no need to adjust a shape of the particles by crushing or the like, and as a result, particles with a small specific surface area can be obtained. In the wet method, the particles having a particle diameter significantly smaller than an average particle diameter are hardly generated, and the specific surface area tends to be smaller after baking. In the wet method, the amount of the impurity element such as titanium can be adjusted by adjusting impurities of the silica source, and the above-described impurity element can be uniformly dispersed in the particles.

Examples of the wet method include a spraying method and an emulsion gelling method. In the emulsion gelling method, for example, a dispersion phase containing a silica precursor and a continuous phase are emulsified, and the obtained emulsion is gelled to obtain a spherical silica precursor. In an emulsification method, it is preferable to prepare an emulsion by supplying the dispersion phase containing the silica precursor to the continuous phase through a fine pore portion or a porous film. Accordingly, an emulsion having a uniform liquid droplet diameter is prepared, and as a result, spherical silica having a uniform particle diameter is obtained. Such an emulsification method may be a micromixer method or a film emulsification method. For example, the micromixer method is disclosed in WO2013/062105.

A pore volume of the spherical silica precursor obtained by the wet method is preferably 0.3 ml/g to 2.2 ml/g. In the case where the pore volume of the silica precursor is 0.3 ml/g or more, the silica particle sufficiently shrink during baking, and the specific surface area can be reduced. The pore volume of the silica precursor is preferably 0.3 ml/g or more, more preferably 0.6 ml/g or more, and still more preferably 0.7 ml/g or more. In the case where the pore volume of the silica precursor is 2.2 ml/g or less, it is possible to prevent an excessive increase in prepared bulk density before baking, and to improve productivity. The pore volume of the silica precursor is preferably 2.2 ml/g or less, more preferably 1.8 ml/g or less, and most preferably 1.5 ml/g or less.

The pore volume is determined by a BJH method based on a nitrogen adsorption method using a specific surface area and pore distribution measuring device (for example, “BELSORP-mini II” manufactured by MicrotracBEL Corp., “TriStar II” manufactured by Micromeritics Instrument Corporation).

An ignition loss of the silica precursor obtained by the wet method is preferably 5.0 mass % to 15.0 mass %. The ignition loss is a sum of a mass of adhering water adhered to the silica precursor and a mass of water generated from condensation of the silanol group contained in the silica precursor, and the silica precursor has an appropriate silanol group, so that the condensation progresses during baking, and the silanol group easily decreases. In the case where the ignition loss is too large, a yield during baking is lowered and productivity deteriorates, and thus, the ignition loss of the silica precursor is preferably 15.0 mass % or less, more preferably 13.0 mass % or less, and most preferably 12.0 mass % or less. In the case where the ignition loss is too small, the silanol group is likely to remain during baking, and thus, the ignition loss of the silica precursor is preferably 5.0 mass % or more, more preferably 6.0 mass % or more, and most preferably 7.0 mass % or more.

Here, the ignition loss is obtained as the mass loss when 1 g of the silica precursor is heated and dried at 850° C. for 0.5 hours in accordance with JIS K0067:1992.

The spherical silica particles are obtained by performing the heat treatment on the spherical silica precursor. In the heat treatment, when the spherical silica particles are baked to densify the shell, the amount of the silanol group on the surface is reduced to cause the dielectric loss tangent to decrease. The temperature of the heat treatment is preferably 700° C. or higher, more preferably 800° C. or higher, and most preferably 900° C. or higher. In the case where the temperature becomes too high, the particles tend to aggregate and particle gauge in the resin composition becomes large, and thus, the temperature is preferably 1600° C. or lower, more preferably 1500° C. or lower, and most preferably 1400° C. or lower. That is, the heat treatment is preferably performed in a range of 700° C. to 1600° C.

A method for the heat treatment is not particularly limited, and examples thereof include a heat treatment by a stationary method, a heat treatment by a rotary kiln method, and a heat treatment by spray combustion.

The spherical silica particles obtained in the above step may be aggregated by the drying or baking step, and thus may be disintegrated into a handleable aggregation diameter. However, in the present invention, the spherical silica particles can be directly mixed with a solvent to obtain a silica particle dispersion.

Examples of the disintegration method include a method using a mortar, a method using a dry or wet ball mill, a method of using a sieve shaker, or a method of using a disintegrator such as a pin mill, a cutter mill, a hammer mill, a knife mill, a roller mill or a jet mill.

In this way, the spherical silica particles used in the silica particle dispersion of the present invention are obtained.

### (Preparation of Silica Particle Dispersion)

The obtained spherical silica particles are mixed with a solvent to obtain a silica particle dispersion. A method for producing a silica particle dispersion of the present invention includes mixing a solvent and a powder of spherical silica particles, and subjecting the mixed liquid to a dispersion treatment, followed by classifying to remove aggregates of the spherical silica particles. The spherical silica particles have a median diameter d50 of 0.5 μm to 20 μm and a product A×d50, which is a product of a specific surface area A (m²/g) and the median diameter d50 (μm), of 2.7 μm·m²/g to 5.0 μm·m²/g. The type and amount of the solvent, and other physical properties of the spherical silica particles are as described above.

The powder of the spherical silica particles is preferably mixed in the silica particle dispersion at a proportion of 10 mass % to 85 mass %. When the proportion of the spherical silica particles is too small, the productivity of the subsequent concentration step may decrease, and when the proportion is too large, the viscosity of the silica particle dispersion may increase excessively and the productivity of the dispersion treatment may decrease. Therefore, the proportion of the spherical silica particles is preferably in the range of 10 mass % to 85 mass %. The amount of the spherical silica particles used is more preferably 15 mass % or more, still more preferably 20 mass % or more, and particularly preferably 25 mass % or more, and is more preferably 80 mass % or less, still more preferably 75 mass % or less, particularly preferably 70 mass % or less, and most preferably 60 mass % or less.

For a dispersion treatment of a mixed liquid containing the solvent and the spherical silica particles, a dispersion device used for pigment dispersion or the like can be used. Examples thereof include a mixer such as a disper, a homomixer, or a planetary mixer, a homogenizer (“CLEARMIX” manufactured by M Technique Co., Ltd., “FILMIX” manufactured by PRIMIX Corporation, or “Abramix” manufactured by Silverson Co., Ltd.), a paint conditioner (manufactured by Red Devil, Inc.), a colloid mill (“PUC colloid mill” manufactured by PUC Inc. and “colloid mill MK” manufactured by 1KA), a cone mill (“cone mill MKO” manufactured by IKA), a media type disperser such as a ball mill, a sand mill (“DYNO-MILL” manufactured by SHINMARU ENTERPRISES CORPORATION), an attritor, a pearl mill (“DCP mill” manufactured by Eirich), and a coball mill; a medialess disperser such as a wet jet mill (“Genus PY” manufactured by Genus Corporation, “STAR BURST” manufactured by Sugino Machine Limited., “Nanomizer” manufactured by NANOMIZER Inc.), “ClEAR SS-5” manufactured by M Technique Co., Ltd., and “MICROS” manufactured by Nara Machinery Co., Ltd.; and other roll mills and kneaders. In the above, a crushing media (ball, bead, or the like) is preferably not used. This is because when a crushing media is used, contamination of the worn media is concerned. Specifically, a wetiet mill (for example, “Genus PY” manufactured by Genus Corporation, “STAR BURST” manufactured by Sugino Machine Limited., “Nanomizer” manufactured by NANOMIZER Inc.), and the medialess disperser such as “ClEAR SS-5” manufactured by M Technique Co., Ltd., or “MICROS” manufactured by NARA MACHINERY CO., LTD. are desirable.

A temperature during the dispersion treatment is preferably 0° C. to 100° C. Here, the temperature during the dispersion treatment refers to a temperature range before and after the treatment. By performing the dispersion treatment in the temperature range, the viscosity of the solvent is appropriately maintained, the productivity is maintained, and evaporation of the solvent is prevented and a solid content can be easily controlled. The treatment temperature is more preferably 5° C. or higher, and still more preferably 10° C. or higher, and is more preferably 90° C. or lower, and still more preferably 80° C. or lower.

A time of the dispersion treatment may be appropriately set depending on the dispersion device to be used such that the particle breakage does not proceed, and is preferably 0.5 minutes to 60 minutes, more preferably 0.5 minutes to 10 minutes, and still more preferably 0.5 minutes to 5 minutes.

Thereafter, aggregates of the spherical silica particles remained without being dispersed even in the dispersion treatment are subjected to wet classification. The wet classification includes classification using a sieve or a centrifugal force. In the case of using the sieve, the classification is preferably performed by a sieve having an opening of 100 μm or less. As the sieve, for example, a metal having a dense lattice structure such as an electroformed sieve is preferably used.

The opening of the sieve is preferably 100 μm or less, more preferably 75 μm or less, still more preferably 50 μm or less, and particularly preferably 35 μm or less. A lower limit of the opening of the sieve is preferably 0.2 μm or more, more preferably 0.5 μm or more, and still more preferably 1 μm or more. That is, the opening of the sieve is preferably in the range of 0.2 μm to 100 μm.

Thereafter, dilution or concentration may be performed as necessary to adjust a concentration to an appropriate value. Examples of the concentration method include vaporization and concentration, and solid-liquid separation.

In the method for producing a silica particle dispersion of the present invention, a silane coupling agent may be added to the mixed liquid of the solvent and the spherical silica particles. Examples of the silane coupling agent include the silane coupling agents described above.

### <Resin Composition>

The silica particle dispersion of the present invention can be mixed with a resin and used as a resin composition. The resin composition preferably includes 5 mass % to 70 mass % of the spherical silica particles, and more preferably 10 mass % to 50 mass % of the spherical silica particles.

The resin may use one or two or more types of a polyamide such as an epoxy resin, a silicone resin, a phenol resin, a melamine resin, a urea resin, unsaturated polyester, a fluororesin, polyimide, polyamide-imide, or polyether imide; a polyester such as polybutylene terephthalate or polyethylene terephthalate; polyphenylene sulfide, aromatic polyester, polysulfone, a liquid crystal polymer, polyethersulfone, polycarbonate, a maleic imide modified resin, an ABS resin, an acrylonitrile-acrylic rubber-styrene (AAS) resin, an acrylonitrile-ethylene-propylene-diene rubber-styrene (AES) resin, a poly tetrafluoroethylene (PTFE), a tetrafluoroethylene-perfluoroalkyl vinyl ether copolymer (PFA), a tetrafluoroethylene-hexafluoropropylene copolymer (FEP), and a tetrafluoroethylene-ethylene copolymer (ETFE). Since the dielectric loss tangent in the resin composition also depends on characteristics of the resin, the resin to be used may be selected in consideration of this factor.

The resin composition may include optional components in addition to the resin and the medium. Examples of the optional component include a dispersion aid, a surfactant, and a filler other than silica.

When a resin film is produced using the resin composition of the present invention, the dielectric loss tangent is preferably 0.012 or less, more preferably 0.010 or less, and still more preferably 0.009 or less at a frequency of 10 GHz. In the case where the dielectric loss tangent at the frequency of 10 GHz of the resin film is 0.012 or less, the resin film can be expected to be used for electronic devices, communication devices, and the like because of excellent electrical characteristics. As the dielectric loss tangent is smaller, a transmission loss of a circuit is reduced, and thus, a lower limit value thereof is not particularly limited.

The dielectric loss tangent can be measured using a split post dielectric resonator (SPDR) (for example, manufactured by Agilent Technologies Japan, Ltd.).

The resin film preferably has an average coefficient of linear expansion of 10 ppm/° C. to 50 ppm/° C. When the average coefficient of linear expansion is in the above range, the range is close to a coefficient of thermal expansion of a copper foil widely used as a base material, and thus, the electrical characteristics are excellent. The average coefficient of linear expansion is more preferably 12 ppm/° C. or more, still more preferably 15 ppm/° C. or more, and more preferably 40 ppm/° C. or less, and still more preferably 30 ppm/° C. or less.

The average coefficient of linear expansion is determined by heating the resin film at a load of 5 N and a temperature increase rate of 2° C./min, measuring a dimensional change of a sample from 30° C. to 150° C., and calculating an average with using a thermomechanical analyzer (for example, “TMA-60” manufactured by SHIMADZU CORPORATION).

The silica particle dispersion of the present invention can be used as various fillers, and can be particularly and suitably used as a filler in resin compositions used for production of an electronic substrate used in an electronic device such as a personal computer, a laptop, and a digital camera, and a communication device such as a smartphone and a game console. Specifically, the silica particle dispersion of the present invention is expected to be applied to a resin composition, a prepreg, a metal foil-clad laminate, a printed wiring board, a resin sheet, an adhesive layer, an adhesive film, a solder resist, a bump reflow, a rewiring insulating layer, a die bond material, a sealing material, an underfill, a mold underfill, a laminated inductor, and the like in order to achieve the low dielectric loss tangent, the low transmission loss, the low moisture absorption, and the improved peel strength.

### EXAMPLES

Hereinafter, the present invention will be described with reference to Examples, but the present invention is not limited thereto. In the following description, common components employ the same substance.

Examples 1 to 7 are working examples, and Examples 8 to 10 are comparative examples.

### Test Example 1

In Test Example 1, spherical silica particles and a silica particle dispersion using the obtained spherical silica particles were prepared.

### Example 1

Silica powder 1 (H-31, d50=3.5 m, manufactured by AGC Si-Tech Co., Ltd.) produced by a wet method was used as the spherical silica precursor. An alumina crucible was filled with 150 g of silica powder 1, followed by heat-treating in an electric furnace with a temperature of 1200° C. for 1 hour. After the heat treatment, the mixture was cooled to the room temperature, and was pulverized in an agate mortar to thereby obtain the spherical silica powder which is an aggregate of the spherical silica particles.

To a 250 ml plastic bottle, 100 g of the obtained spherical silica powder and 43 g of methyl ethyl ketone (MEK) were put, followed by stirring at 30 rpm for 2 hours with a mixed rotor. An operation of ejecting the obtained mixed liquid from a nozzle of φ0.1 mm at a pressurized pressure of 100 MPa using a wet pulverization and dispersion device (Star Burst Mini manufactured by Sugino Machine Co., Ltd., model number: HJP-25001) was repeated three times. The obtained slurry was passed through an electroformed sieve with an opening of 10 μm to obtain a silica particle dispersion having a solid content of 70 mass %.

### Example 2

Except that silica powder 2 (H-51, d50=5.5 μm, manufactured by AGC SI Tech Co., Ltd.) produced by a wet method was used as the spherical silica precursor, the silica particle dispersion was obtained in the same manner as in Example 1.

### Example 3

Except that silica powder 3 (H-121, d50=13 μm, manufactured by AGC SI Tech Co., Ltd.) produced by a wet method was used as the spherical silica precursor, and that the slurry was passed through an electroformed sieve with an opening of 30 μm, the silica particle dispersion was obtained in the same manner as in Example 1.

### Example 4

Except that silica powder 4 (H-201, d50=20 μm, manufactured by AGC SI Tech Co., Ltd.) produced by a wet method was used as the spherical silica precursor, and that the slurry was passed through an electroformed sieve with an opening of 40 m, the silica particle dispersion was obtained in the same manner as in Example 1.

### Example 5

To a 250 ml plastic bottle, 100 g of the spherical silica powder obtained in Example 4, 43 g of methyl ethyl ketone (MEK), and 0.10 g of KBM-503 (3-methacryloxypropyltrimethoxysilane manufactured by Shin-Etsu Chemical Co., Ltd.) were put, followed by stirring at 30 rpm for 2 hours with a mixed rotor. An operation of heating the obtained mixed liquid at 80° C. for 1 hour, followed by cooling, and ejecting the obtained mixed liquid from a nozzle of φ0.1 mm at a pressurized pressure of 100 MPa using a wet pulverization and dispersion device (Star Burst Mini manufactured by Sugino Machine Co., Ltd., model number: HJP-25001) was repeated three times. The obtained slurry was passed through an electroformed sieve with an opening of 10 m to obtain a silica particle dispersion having a solid content of 70 mass %.

### Example 6

To a 250 ml plastic bottle, 100 g of the spherical silica powder obtained in Example 4, 43 g of methyl ethyl ketone (MEK), and 0.10 g of BYK (registered trademark)-R606 (polyhydroxycarboxylic acid ester, manufactured by BYK) were put, followed by stirring at 30 rpm for 2 hours with a mixed rotor. An operation of ejecting the obtained mixed liquid from a nozzle of φ0.1 mm at a pressurized pressure of 100 MPa using a wet pulverization and dispersion device (Star Burst Mini manufactured by Sugino Machine Co., Ltd., model number: HJP-25001) was repeated three times. The obtained slurry was passed through an electroformed sieve with an opening of 10 μm to obtain a silica particle dispersion having a solid content of 70 mass %.

### Example 7

A silica particle dispersion was obtained in the same manner as in Example 5 except that KBM-503 in Example 5 was changed to 0.10 g of KBM-103 (trimethoxyphenylsilane, manufactured by Shin-Etsu Chemical Co., Ltd.).

### Example 8

Spherical silica powder 5 (manufactured by Denka Company Limited: FB-5D) produced from silica as a raw material which is produced by a dry method was used. An alumina crucible was filled with 150 g of the spherical silica powder 5, followed by heat-treating in an electric furnace with a temperature of 1300° C. for 1 hour. After the heat treatment, the mixture was cooled to the room temperature, and was pulverized in an agate mortar to thereby obtain the spherical silica powder. A silica particle dispersion was obtained in the same manner as in Example 1 using the obtained spherical silica powder.

### Example 9

A silica particle dispersion was obtained in the same manner as in Example 1 using spherical silica powder 6 (manufactured by ADMATECHS COMPANY LIMITED: SC-04) produced from the silica as the raw material which is produced by a VMC method.

### Example 10

The spherical silica powder (10 g) obtained in Example 4 was used as it was.

Table 1 shows results of measuring a specific surface area, a median diameter, a viscosity of a kneaded product, and a viscosity of a 70 mass % dispersion of the spherical silica powder prepared in each example described above.

### 1. Specific Surface Area

The spherical silica particles were dried under reduced pressure at 230° C. to completely remove water, thereby obtaining a sample. Regarding this sample, the specific surface area was obtained by a multi-point BET method using a nitrogen gas in “Tri Star II”, which is an automatic specific surface area and pore distribution measuring device manufactured by Micromeritics Instrument Corporation.

### 2. Median Diameter

The median diameter was measured by a laser diffraction particle size distribution analyzer (MT3300EXII manufactured by MicrotracBEL Corp.). The measurement was performed after the spherical silica particles were dispersed by irradiating ultrasonic waves three times each for 60 seconds in the device. The measurement was performed twice each for 60 seconds, and an average value was obtained.

### 3. Viscosity of Kneaded Product

The boiled linseed oil (6 parts by mass) (manufactured by Yamakei Sangyo Co., Ltd.) and the spherical silica particles (8 parts by mass) were mixed, followed by kneading with Awatori Rentaro (manufactured by Thinky Corporation) as a planetary mixer at 2000 rpm for 3 minutes to prepare a kneaded product. The obtained kneaded product was measured for 30 seconds at a shear rate of 1 s⁻¹ using a rotary rheometer, and the viscosity was obtained at 30 seconds. The viscosity measured only with the boiled linseed oil was 46 mPa·s.

### 4. Viscosity of Silica Particle Dispersion

To a 100 ml plastic bottle, 42 g of the spherical silica particles and 18 g of methyl ethyl ketone (MEK) were put (solid content concentration of 70 mass %), followed by stirring at 30 rpm for 2 hours with a mixed rotor. An operation of ejecting the obtained mixed liquid from a nozzle of φ0.1 mm at a pressurized pressure of 50 MPa using a wet pulverization and dispersion device (Star Burst Mini manufactured by Sugino Machine Co., Ltd., model number: HJP-25001) was repeated three times. The obtained slurry was adjusted to 25° C., a viscosity thereof was measured for 30 seconds at a shear rate of 1 rpm using a rotary rheometer (modular rheometer Physica MCR-301 manufactured by Anton Paar), and the viscosity obtained at 30 seconds was determined.

### Test Example 2

### (Preparation of Evaluation Sample A (Resin Film))

A resin film was prepared using the silica particle dispersions of Examples 1 to 9 and the spherical silica powder of Example 10.

In 13 parts by mass of methyl ethyl ketone (MEK), 25 parts by mass of a biphenyl type epoxy resin (epoxy equivalent: 276, “NC-3000” produced by Nippon Kayaku Co., Ltd.) were dissolved by heating while stirring. The obtained mixture was cooled to room temperature, and mixed with 32 parts by mass of an active ester-based curing agent (“HP 8000-65T” manufactured by DIC Corporation, active group equivalent: 223, toluene solution containing 65 mass % of non-volatile components), followed by kneading at 2000 rpm for 5 minutes with Awatori Rentaro, mixing 0.9 parts by mass of 4-dimethylaminopyridine (DMAP) and 1.6 parts by mass of 2-ethyl-4-methyl imidazole (“2E4MZ”, manufactured by Shikoku Chemicals Corporation) as curing accelerators, and mixing at 2000 rpm for 5 minutes using Homo disperser. The silica particle dispersion or the spherical silica powder was weighed and mixed therein so as to obtain 90 parts by mass of particle powder, followed by mixing at 2000 rpm for 5 minutes using Homo disperser.

Next, a transparent polyethylene terephthalate (PET) film (“PET5011 550” manufactured by Lintec Corporation, thickness: 50 m) which was subjected to a mold release treatment was prepared. The obtained varnish was applied to a release-treated surface of the PET film using an applicator so as to have a thickness after drying of 40 μm, followed by drying in a gear oven at 100° C. for 10 minutes, and then cutting to prepare an uncured laminated film including an uncured resin film (B-stage film) of 200 mm in length×200 mm in width×40 μm in thickness.

The obtained uncured laminated film was heated in a gear oven set to 190° C. for 90 minutes to cure the uncured resin film, thereby preparing a cured film.

### (Preparation of Evaluation Sample B (Laminate))

### (1) Laminating Step

A single-sided roughened copper foil (F0-WS, thickness of 18 μm, surface roughness Rz=1.2 μm, manufactured by Furukawa Electric Co., Ltd.) was prepared. The uncured laminated film prepared as described above was laminated on the copper foil using a “batch type vacuum laminator MVLP-500-IIA” manufactured by MEIKI CO., LTD. such that a surface of the uncured resin film (B-stage film) faced a roughened copper foil surface, thereby obtaining a laminated structure including the copper foil/B-stage film/PET film. The lamination was performed under the following conditions: pressure reduction was performed for 30 seconds to set an atmospheric pressure to 13 hPa or less, and then pressing was performed for 30 seconds at 100° C. under a pressure of 0.8 MPa.

### (2) Film Peeling Step

The PET film of the laminated structure was peeled off.

### (3) Curing Step

A laminated plate was placed in a gear oven having an internal temperature of 180° C. for 30 minutes to cure the B-stage film, thereby forming an insulating layer.

### (Evaluation)

### 1. Measurement of Peel Strength

For the evaluation sample B, a cut was made in a strip shape on the copper foil side so as to have a width of 1 cm. The substrate was set in a 900 peel tester, a copper-plated end with the cut was picked up with a gripper, the copper plating was peeled by 20 mm, and peel strength (N/cm) was measured.

### 2. Graininess of Coated Film

The appearance of the uncured laminated film was observed to evaluate graininess of a coating film. Evaluation criteria were as follows. The evaluation of A and B was judged to be practical.

### [Evaluation Criteria]

A (good): No graininess.
B (fair): Fine irregularities were observed after coating.
C (Poor): Streaks were observed due to adhesion of coarse particles during coating.

The test results are shown in Table 1.

TABLE 1

| | | | Product of | | | Viscosity of | | |
|---|---|---|---|---|---|---|---|---|
| | | | specific | Viscosity of | | dispersion | | |
| | Specific | | surface area | kneaded | | containing 70 | | |
| | surface | Median | and median | product | Whether | mass % of | Peel | Graininess |
| | area | diameter | diameter | at 1 s⁻¹ | dispersion | particles | strength | of coated |
| | m²/g | μm | μm · m²/g | mPa · s | prepared | mPa · s | N/mm | film |
| Example 1 | 1.3 | 3 | 3.9 | 3150 | Yes | 2,000 | 70 | A |
| Example 2 | 0.6 | 5 | 3.0 | 2200 | Yes | 1,700 | 90 | A |
| Example 3 | 0.4 | 8 | 3.2 | 320 | Yes | 1,200 | 100 | A |
| Example 4 | 0.2 | 18 | 3.6 | 250 | Yes | 950 | 110 | B |
| Example 5 | 0.2 | 18 | 3.6 | 3150 | Yes | 1,700 | 120 | A |
| Example 6 | 0.2 | 18 | 3.6 | 3150 | Yes | 1,800 | 110 | A |
| Example 7 | 0.2 | 18 | 3.6 | 3400 | Yes | 2,000 | 110 | B |
| Example 8 | 2 | 4.7 | 9.4 | 18000 | Yes | 31,000 | 25 | C |
| Example 9 | 4.5 | 1.5 | 6.8 | 11000 | Yes | 22,000 | 40 | C |
| Example 10 | 0.2 | 18 | 3.6 | 3150 | No | 4,000 | 50 | C |

From Table 1, it was found that Examples 1 to 7 had higher peel strength and stronger adhesive force than Examples 8 and 10. Further, Examples 1 to 7 had good grade of graininess of the coated film, and all were suitable for practical use. On the other hand, in Examples 8 and 10, the peel strength was low, and graininess of the coated film was also observed.

Although the present invention has been described in detail with reference to specific embodiments, it is apparent to those skilled in the art that various changes and modifications can be made without departing from the spirit and scope of the present invention. The present application is based on a Japanese Patent Application (No. 2022-077093) filed on May 9, 2022, the contents of which are incorporated herein by reference.

1. A silica particle dispersion comprising spherical silica particles and a solvent, wherein the spherical silica particles have a median diameter d50 of 0.5 μm to 20 μm, and a product A×d50 of 2.7 μm·m²/g to 5.0 μm·m²/g, the product A×d50 being a product of a specific surface area A (m²/g) of the spherical silica particles and the median diameter d50 (μm).

2. The silica particle dispersion according to claim 1, wherein the spherical silica particles have a specific surface area of 0.1 m²/g to 10 m²/g.

3. The silica particle dispersion according to claim 1, wherein the spherical silica particles have a viscosity measured by the following measurement method of 5,000 mPa·s or less,
(measurement method)
the silica particle dispersion is dried to obtain powdery spherical silica particles, 8 parts by mass of the powdery spherical silica particles obtained and 6 parts by mass of boiled linseed oil are mixed and kneaded at 2000 rpm for 3 minutes to obtain a kneaded product, and the kneaded product is measured for 30 seconds at a shear rate of 1 s⁻¹ using a rotary rheometer to determine the viscosity at 30 seconds.

4. The silica particle dispersion according to claim 1, further comprising a silane compound having at least one group selected from the group consisting of a vinyl group, a phenyl group, a phenylamino group, an alkyl group having 4 or more carbon atoms, a methacrylic group, and an epoxy group.

5. The silica particle dispersion according to claim 1, further comprising an organic thixotropic agent.

6. The silica particle dispersion according to claim 1, wherein the solvent comprises at least one selected from the group consisting of water, hydrocarbons, alcohols, acetate esters, ketones, cellosolves, glycol ethers, chlorohydrocarbons, and polar solvents.

7. The silica particle dispersion according to claim 1, having a viscosity of 20 mPa·s to 20,000 mPa·s at 25° C. when a solid content concentration of the spherical silica particles is 70 mass %.

8. A resin composition comprising the silica particle dispersion according to claim 1.

9. A method for producing a silica particle dispersion, the method comprising:
mixing a solvent with powder of spherical silica particles, the spherical silica particles having a median diameter d50 of 0.5 μm to 20 μm and a product A×d50, which is a product of a specific surface area A (m²/g) and the median diameter d50 (μm), of 2.7 μm·mm²/g to 5.0 μm·m²/g; and
subjecting the mixed liquid to dispersion treatment, followed by classifying to remove aggregates of the spherical silica particles.
